(19) United States
(12) Patent Application Publication
(10) Pub. No.: US 2015/0197127 A1
(43) Pub. Date: Jul. 16, 2015

(54) Actuation of Trailer Jacks

(71) Applicant: Dion Magestro, Masury, OH (US)

(72) Inventor: Dion Magestro, Masury, OH (US)

(21) Appl. No.: 14/595,133

(22) Filed: Jan. 12, 2015

Related U.S. Application Data
(60) Provisional application No. 61/926,680, filed on Jan. 13, 2014.

(51) Int. Cl. B60D 1/66; B60S 9/18; F16D 1/02; B66F 3/08; B66F 3/44

(52) U.S. Cl. CPC B60D 1/66; B66F 3/08; B66F 3/44; F16D 1/02; B60S 9/18

(57) ABSTRACT

Apparatus for actuating a trailer jack having a carrier shaft or drive shaft with an exposed end portion includes an adapter that is connectable to the end portion of the carrier shaft or drive shaft in driving relationship and a drive member that is connectable to the adapter in driving relationship. A driving member such as a drill chuck of an electric drill can be connected to the drive member. The connection between the adapter and the drive member preferably is made by specially shaped members that cannot easily be engaged or operated by commonly available tools. The apparatus can be provided on an OEM basis or it can be provided as an aftermarket modification to existing jacks. A crank can be provided to permit manual actuation of the jack in the event that an electric drill is not available or is inoperable.

### REFERENCE TO PROVISIONAL APPLICATION

The present application claims priority to U.S. provisional application Ser. No. 61/926,680, entitled Trailer Jack and Method of Actuation, filed Jan. 13, 2014 by Dion Magestro, the disclosure of which is incorporated herein by reference in its entirety.

### BACKGROUND OF THE INVENTION

1. Field of the Invention

The invention relates generally to jacks and, more specifically, to a device particularly suited to actuate a trailer jack. Although the present invention largely is described with reference to a “trailer jack,” it is to be understood that the device and method of the present invention are not limited to use with trailer jacks and, indeed, they can be used with other types of jacks or other equipment or for other purposes as those skilled in the art will appreciate. Accordingly, use of the phrase “trailer jack” or “jack” herein is for convenience of description and is not to be construed as limiting the operation or use of the invention to only trailer jacks.

2. Description of the Prior Art

Trailers are used to haul heavy and/or large objects or materials such as boats, livestock, etc. behind vehicles. Typically the tongue of the trailer is connected to or disconnected from a trailer hitch while the trailer is in an unloaded state so as to minimize the difficulty in raising and lowering the tongue. Nevertheless, a large, unloaded trailer can be sufficiently heavy that it is necessary to use a jack to raise and lower the tongue. Any such difficulty in raising or lowering the tongue is increased if the trailer were to be loaded with cargo at the time it is connected to or disconnected from the trailer hitch. Regardless of the loaded or unloaded condition of the trailer, it often is desirable to use a jack to maintain the trailer in a generally horizontal position while it is disconnected from a vehicle.

Trailer jacks often are permanently attached to trailer tongues and actuated manually by means of a crank. The jack with its attached crank often can be folded to a stowed position so that it is unobtrusive during travel or other trailer operations. Trailer jacks of the type described are commercially available from a number of manufacturers, including Cequent Performance Products, 47912 Halyard Drive, Suite 100, Plymouth, Mich. 48170 (“BULLDOG” trailer jacks) and Shelby Industries, LLC, 175 McDaniel Road, Shelbyville, Ky. 40065.

Most of the trailer jacks in question have a load plate that is connected to a housing. An internal tube having a base or caster wheel is disposed within the housing for telescoping movement relative to the housing. A rotatable, threaded carrier shaft interconnects the housing and the internal tube. The load plate can be connected to the tongue of a trailer or other object to be lifted. The direction of movement of the load plate relative to the base or caster wheel depends on the direction in which the carrier shaft is rotated.

A carrier bevel gear sometimes is disposed at one end of the carrier shaft. A drive bevel gear is carried by a drive shaft disposed at right angles to the longitudinal axis of the carrier shaft. The teeth of the drive and carrier bevel gears intersect with each other. By this construction, rotation of the drive shaft causes the carrier shaft to rotate thereby moving the housing, and hence the load plate, relative to the base or caster wheel.

Typically, the carrier shaft is rotated by a crank that extends through the center of the drive shaft. Alternatively, the bevel gears and drive shaft can be dispensed with and the crank can be connected directly to an exposed end of the carrier shaft. In both cases, the crank often can be removed for storage or repositioned to make the assembly more compact.

Over the years, a number of improvements have been made to trailer jacks of the type described. Most notably, the introduction of a power source to operate jacks has significantly improved functionality and ease of use. Although there are a variety of types of trailer jacks on the market, and although some of them are or can be power-operated, a problem still exists concerning the ease of use, actuation speed and cost of the jacks.

Prior efforts have been made to reduce the difficulty of actuating jacks. For example, U.S. Publication No. 2012/0037862 discloses an in-line jack that includes a body, an extendable shaft, drive mechanics and a motor. A planetary gear system also can be provided to connect the motor to a drive shaft. Unfortunately, the components are aligned axially which has the potential to increase the space required for proper jack operation.

Another example of a powered jack is shown in U.S. Publication No. 2007/0256526 in which a portable, battery-operated drill is used to actuate a jack by means of various adaptors or sockets that provide a connection between the drill and the jack. Other examples of similar devices include U.S. Pat. No. 6,910,677; U.S. Pat. No. 6,237,894; U.S. Pat. No. 6,039,126; U.S. Pat. No. 5,897,121, U.S. Pat. No. 5,876,526, U.S. Pat. No. 5,876,526; U.S. Pat. No. 5,771,516; U.S. Pat. No. 1,861,326; U.S. Pat. No. 1,465,057; and United Kingdom Patent No. 2210303-A.

A problem with the referenced devices is that they generally are, either alone or in various combinations, not easily used, very cumbersome, quite expensive or of limited effectiveness. Another problem with prior devices is that their use is not limited to authorized persons, i.e., even if an adapter or socket is provided, it can be operated by unauthorized persons.

Desirably, a device would be available that would enable an authorized user to conveniently operate a trailer jack with a common power source such as a battery-operated electric drill, while preventing operation by unauthorized persons.

### SUMMARY OF THE INVENTION

The present invention provides a new and improved technique for operating a trailer jack that significantly reduces the time and effort required to operate the trailer jack. The invention can be sold as original equipment manufacture (“OEM”) or as part of a trailer jack “kit,” or aftermarket add-on, to modify an existing jack. The present invention is usable with many types of trailer jacks, including those with cranks that connect directly to an end of a carrier shaft and those with cranks that connect to a gearing mechanism such as bevel gears and a drive shaft.

Apparatus according to the invention includes an adapter that is connectable to an end portion of a carrier shaft or drive shaft in driving relationship and a drive member that is connectable to the adapter in driving relationship. A driving member such as a drill chuck of an electric drill can be connected to the drive member. In order to restrict actuation of the jack only to authorized users, the connection between the adapter and the drive member is made by specially shaped members that cannot easily be engaged or operated by commonly available tools. The apparatus can be provided on an OEM basis or it can be provided as an aftermarket modification to existing jacks.

In an aftermarket embodiment, the factory-provided crank is removed, leaving the end of the carrier shaft or drive shaft exposed. For convenience, the exposed end of the carrier shaft or drive shaft will be referred to as the “drive end.” An adapter having first and second ends is provided. The first end is a female end that is fitted over the drive end and secured to the first end, preferably by a torque-limiting member such as a shear pin (or “tension pin”), barrel bolt, or similar member. The tension pin extends through aligned openings in the first end of the adapter and the drive end. The tension pin preferably is intended to retain the adapter in place at the end of the drive end at all times. Alternatively, the tension pin could be sized such that it would be removable or relatively loosely fitted into place; in that event, it would retain the adapter only during times of jack actuation and would be removed, along with the adapter, at other times. The second end of the adapter preferably is a male end that is in the form of a security shape in order to prevent unauthorized operation of the jack. Alternatively, the second end of the adapter can be provided in the form of a square drive or similar shape such as a hex end.

A drive member having first and second ends is included as part of the invention. In one embodiment, the first end of the drive member is a socket that is configured to fit over a substantial portion of the adapter. If the tension pin is removable, the first end includes skirt walls that cover the tension pin and prevent its removal during jack operations. The first end also includes a drive portion disposed within the socket that engages the second end of the adapter in a driving relationship. In another embodiment, the first end of the drive member defines a socket that includes a drive portion that engages the second end of the adapter in a driving relationship. In each embodiment of the drive member, the second end of the drive member is configured to be engaged by the chuck of a typical electric drill motor in a driving relationship. It is expected that the second end of the socket will be hexagonal in shape or will be provided with axially extending channels in order to be securely grasped by the chuck.

The invention can be provided in different sizes to fit jacks of all types, including jacks suitable for use with semi-trailers. In addition, the adapter can be provided in modified form. For example, the second end of the adapter can be in the form of socket opening rather than a male drive end. The socket opening could be of a size and shape suitable for receiving the square drive end of a typical ratchet handle as are commonly provided in toolkits. If this type of adapter is used, the previously described socket-type drive member will not be needed, although the crank will have to include a male end (protrusion) suitable for engaging and rotating the adapter. In yet another variation, the second end of the adapter could be in the form of a socket opening having a security shape, and the previously described drive member could include a male end having a security shape that mates with the security shape of the adapter.

It is expected that the crank will include a handle at one end and a drive member such as a keyed opening or protrusion at the other end. The keyed opening or protrusion is of a size and shape to engage the second end of the adapter in a driving relationship. Accordingly, the user will be able to actuate the jack in the event of a problem such as the drill batteries being discharged or the socket being misplaced or otherwise unavailable.

The invention greatly simplifies the task of raising and lowering a trailer jack, and significantly reduces the time and effort required to conduct jack operations. Not only can the invention be provided as part of new construction or as an aftermarket kit that can be used to retrofit existing jacks, but the actuator (typically a battery-operated electric drill motor) is available to many users and commonly is carried in a truck or other towing vehicle. When supplied in the preferred embodiment, the invention will make it difficult for unauthorized persons to operate the jack, thereby serving as an impediment to theft of the object that is being supported by the jack. The invention is inexpensive and practical, and avoids the drawbacks associated with prior devices of a similar nature.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of a jack according to the invention, showing various actuating components aligned with a longitudinal axis of a carrier shaft;

FIG. 2 is an enlarged side elevational view, partly in section, of a portion of the invention of FIG. 1;

FIG. 3 is a view similar to FIG. 2 showing an alternate embodiment of the invention in which actuating components are disposed at a right angle to the longitudinal axis of the carrier shaft;

FIG. 4 is a view similar to FIG. 3 showing an alternate form of actuating components similar to those shown in FIGS. 1 and 2;

FIG. 5 is a perspective view of apparatus according to the invention in which an adapter has a “security configuration” and a drive member includes a socket having a configuration that mates with the security configuration of the adapter;

FIG. 6 is a view similar to FIG. 3 showing a particular form of security configuration and drive member;

FIG. 7 is a view similar to FIG. 5 showing a crank having a drive member according to the invention that can be used to manually operate a trailer jack; and

FIG. 8 is a view similar to FIG. 5 in which a drive member has a “security configuration” and an adapter includes a socket having a size and shape that mates with the security configuration of the drive member.

### DESCRIPTION OF THE PREFERRED EMBODIMENT

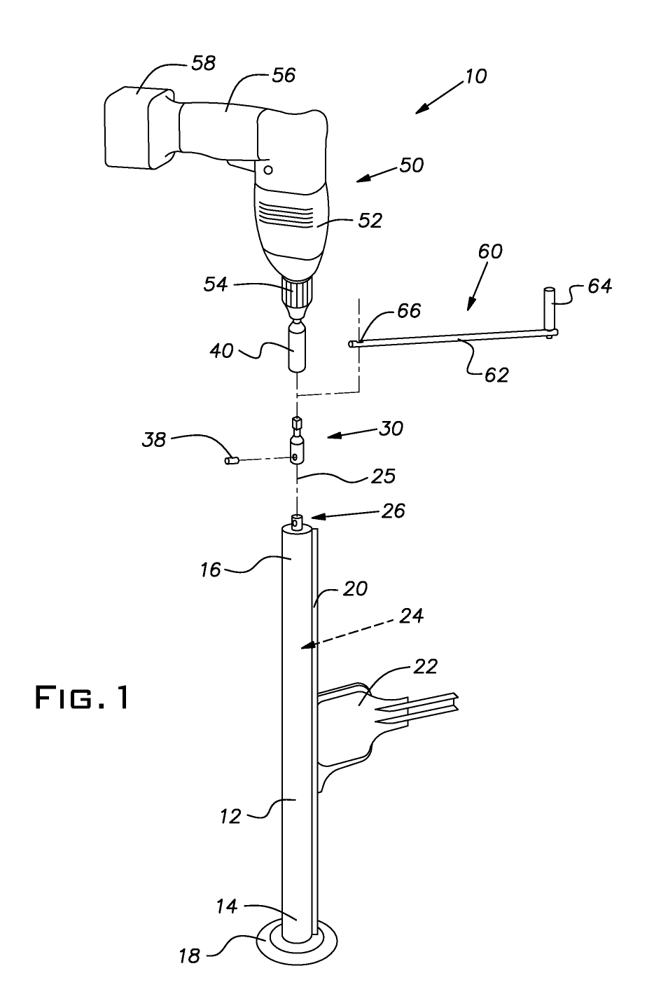

Referring to FIG. 1, apparatus according to the invention is indicated generally by the reference numeral 10. The apparatus 10 includes a jack having an elongate outer housing 12 having first and second ends 14, 16. A base plate 18 is attached to an inner housing (not shown) that projects out of the first end 14. The housing 12 includes an elongate support rib 20. A load plate 22 is connected as by welding to the outer housing 12 for movement therein. If desired, the base plate 18 could be replaced by a caster wheel.

A carrier shaft 24 is disposed within the outer housing 12. The carrier shaft 24 has a longitudinal axis 25 coincident with that of the outer housing 12. The carrier shaft 24 has external threads (not shown) that are engaged by the inner housing. Accordingly, when the carrier shaft 24 is rotated about its longitudinal axis 25, the inner housing and the attached base plate 18 or caster wheel will be moved telescopically relative to the outer housing 12. The direction of movement of the load plate 22 relative to the base plate 18 or the caster wheel will depend on the direction in which the carrier shaft 24 is rotated.

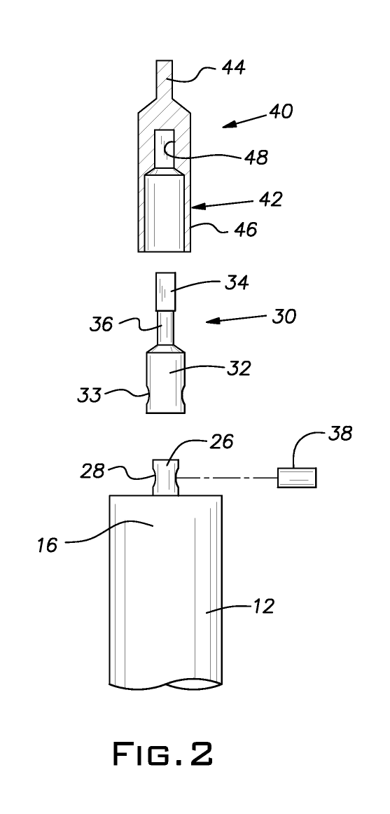

Referring also to FIG. 2, the carrier shaft 24 has an exposed end 26. An opening 28 is formed in the exposed end 26. The opening 28 preferably is cylindrical although other shapes are possible. The opening 28 is disposed at a right angle to the longitudinal axis 25 of the carrier shaft 24.

The jack 10 includes an adapter 30. The adapter 30 has a first end 32, a second end 34, and a shaft or neck 36 that connects the first and second ends 32, 34. The first end 32 has a longitudinally extending opening (not shown) that is adapted to fit over the exposed end 26 of the carrier shaft 24. The first end 32 has a transverse opening 33 of the same general size and shape as that of the opening 28 in the exposed end 26 of the carrier shaft 24. A torque-limiting member in the form of a shear pin (“tension pin”) or barrel bolt 38, is provided. The tension pin 38 is a generally cylindrical member that fits into the openings 28, 33 when they are aligned with each other. The tension pin 38 preferably is press-fitted into the openings 28, 33 so that the adapter 30 cannot be removed. Alternatively, as will be described in more detail, the tension pin 38 can be removable or relatively loosely fitted into the openings 28, 33. The second end 34 preferably is in the form of a unique security shape, although common shapes such as a square end or hex end conceivably could be employed.

The apparatus 10 includes a drive member 40. The drive member 40 has a first end 42 and a second end 44. The first end 42 is in the form of a hollow socket and is of the same size and shape as the external configuration of the adapter 30. The first end 42 is defined by a relatively thin sidewall 46 and includes a drive receptacle 48 at the upper end thereof that is adapted to receive the second end 34 of the adapter 30 in driving relationship. The second end 44 is in the form of a drive member such as a hex end, an end with axially extending channels, or a square end. A hex end or channeled end is preferred.

An electric drill 50 is usable as part of the invention 10. The drill 50 has a motor 52, a chuck 54, a handle 56 with a trigger, and a removable, rechargeable battery pack 58. The drill 50 can be of any well known type, and can be powered by house current rather than a battery pack 58, if desired, and may include other features such as a torque limiter, a reversing motor, etc.

The apparatus 10 includes a crank 60. The crank 60 has an elongate shaft 62, a handle 64 at one end of the shaft 62, and a keyed opening 66 at the other end of the shaft 62. The keyed opening 66 is of a size and shape to fit over, and engage, the drive end 34 of the adapter 30.

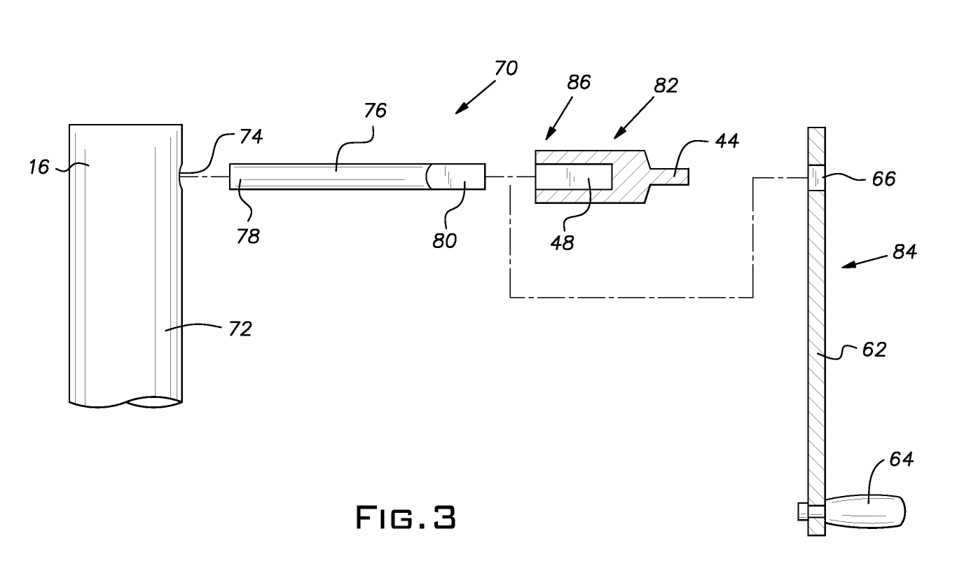

Referring now to FIG. 3, a second embodiment of the invention is indicated by the reference numeral 70. The embodiment 70 shares certain features of the embodiment 10, and like reference numerals will be used to indicate the same or similar features of the two embodiments.

A housing 72 includes an opening 74 that extends through the side thereof adjacent the second end 16. Drive gears (not shown) are disposed within the housing 72 adjacent the second end 16. A drive shaft 76 having first and second ends 78, 80 is provided. The drive shaft 76 is similar to conventionally supplied drive shafts. The first end 78 extends through the opening 74 and engages the drive gears in driving relationship. The second end 80 is in the form of a “security configuration” that is not engageable with commonly sized sockets, wrenches, and other tools.

The embodiment 70 also includes a socket 82 that is similar to the socket 40 and a crank 84 that is similar to the crank 60. The socket 82 includes a hollow, first end 86 and a second end 44 that defines a drive member. The first end 86 is of the same size and shape as the second end 80 of the drive shaft 76 and therefore engages the second end 80 in a driving relationship. The second end 44 preferably is a hex end that can be engaged by the chuck 54. The crank 84, like the crank 60, has a handle 64 and a keyed opening 66. The opening 66 is sized to engage the second end 44 in driving relationship.

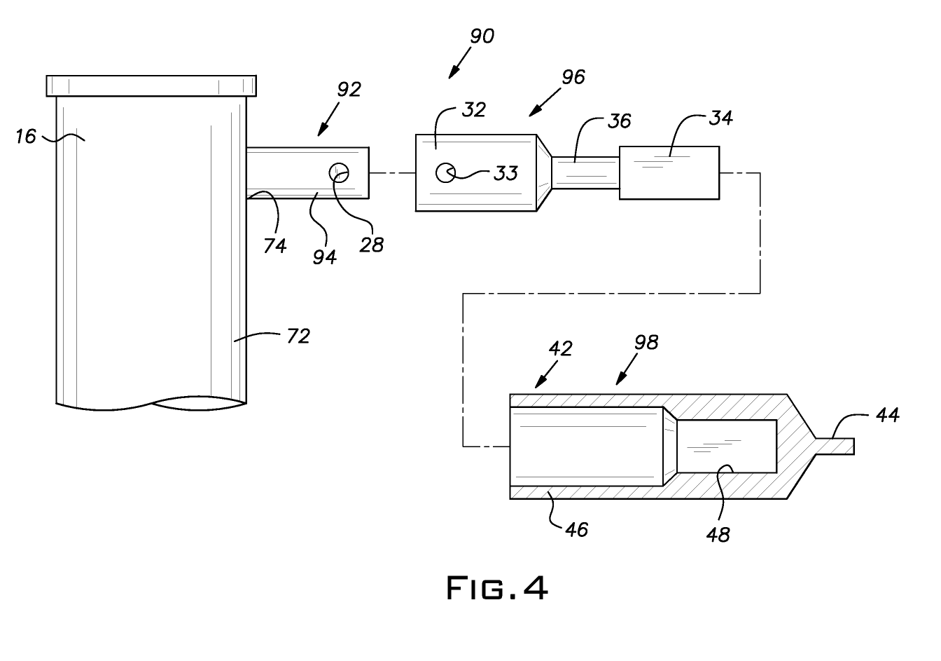

Referring now to FIG. 4, a third embodiment of the invention is indicated by the reference numeral 90. The embodiment 90 shares certain features of the embodiments 10, 70 and like reference numerals will be used to indicate the same or similar features of the various embodiments.

A housing 72 includes an opening 74 that extends through the side thereof adjacent the second end 16. Drive gears (not shown) are disposed within the housing 72 adjacent the second end 16. A drive shaft 92 having a first end (not shown) and a second, exposed end 94 is provided. The first end of the drive shaft 92 extends through the opening 74 and engages the drive gears in driving relationship. The second end 94 includes an opening 28.

The embodiment 90 includes an adapter 96 similar to the adapter 30, a socket 98 similar to the socket 40, and a crank 60 (not shown in FIG. 4). As with the embodiment 10, a tension pin or barrel bolt (not shown) is used to connect the adapter 96 to the exposed second end 94 via aligned openings 28, 33.

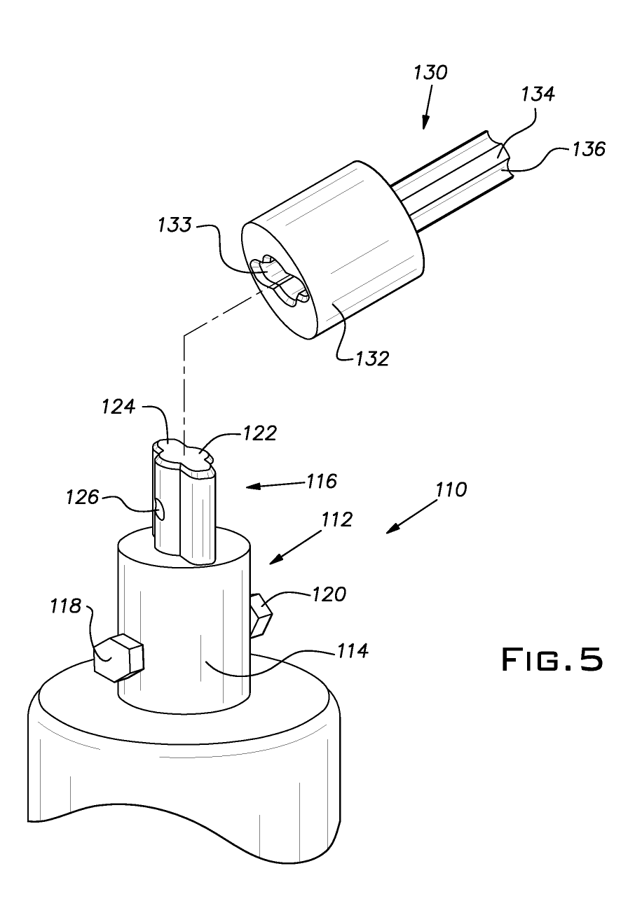

Referring now to FIG. 5, another embodiment of the invention is indicated by the reference numeral 110. The embodiment 110 shares certain features of the embodiment 10, and like reference numerals will be used to indicate the same or similar features of the two embodiments.

The embodiment 110 includes an adapter 112. The adapter 112 has a first end 114 that defines a socket and a second end 116 in the form of a “security configuration.” The first end 114 has a longitudinally extending opening (not shown) that is adapted to fit over the exposed end 26 of the carrier shaft 24. The first end 114 has a transverse opening of the same general size and shape as that of the opening 28 in the exposed end 26 of the carrier shaft 24. A torque-limiting member in the form of a shear pin (“tension pin”) or bolt 118 is provided. The bolt 118 is a generally cylindrical member that fits into the opening 28 and the openings in the first end 114 when they are aligned with each other. The bolt is retained in place by a nut 120. The second end 116 has a cylindrical central portion 122 from which laterally extending, rounded wings 124 extend. A transverse opening 126 extends through the central portion 122 at approximately its mid-point.

The embodiment 110 includes a drive member 130. The drive member 130 has a first end 132 and a second end 134. The first end 132 includes a hollow socket 133 that is of the same size and shape as the external configuration of the second end 116 of adapter 112. The second end 134 is in the form of a drive member having axially extending channels 136 that are particularly adapted to be engaged by the chuck 54 of the drill 50.

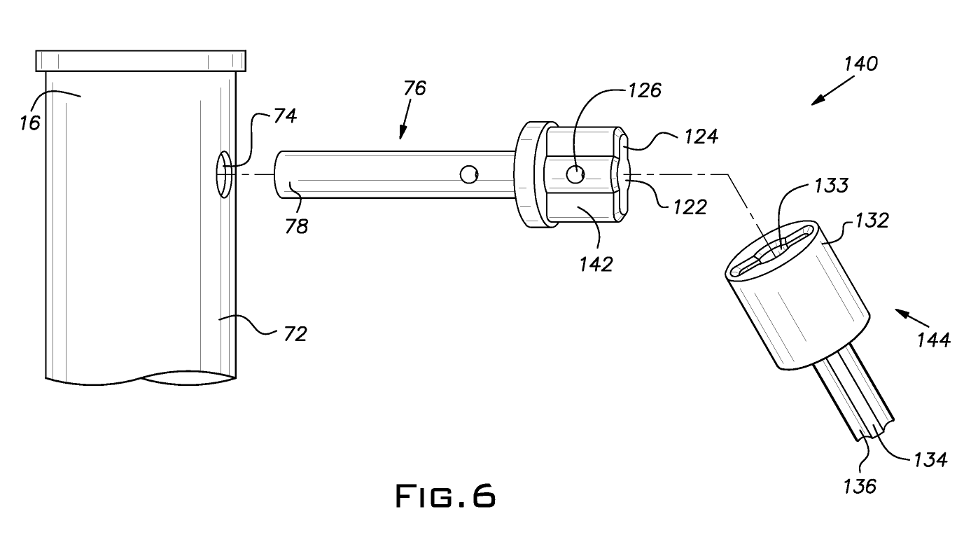

Referring now to FIG. 6, another embodiment of the invention is indicated by the reference numeral 140. The embodiment 140 shares certain features of the embodiments 70, 90, and 110, and like reference numerals will be used to indicate the same or similar features of the various embodiments.

A housing 72 includes an opening 74 that extends through the side thereof adjacent the second end 16. Drive gears (not shown) are disposed within the housing 72 adjacent the second end 16. A drive shaft 76 having first and second ends 78, 142 is provided. The drive shaft 76 is similar to conventionally supplied drive shafts. The first end 78 extends through the opening 74 and engages the drive gears in driving relationship. The second end 142 is in the form of a “security configuration” substantially similar to that of the second end 116 of adapter 112.

The embodiment 140 also includes a drive member 144. The drive member 144 is substantially similar to the drive member 130.

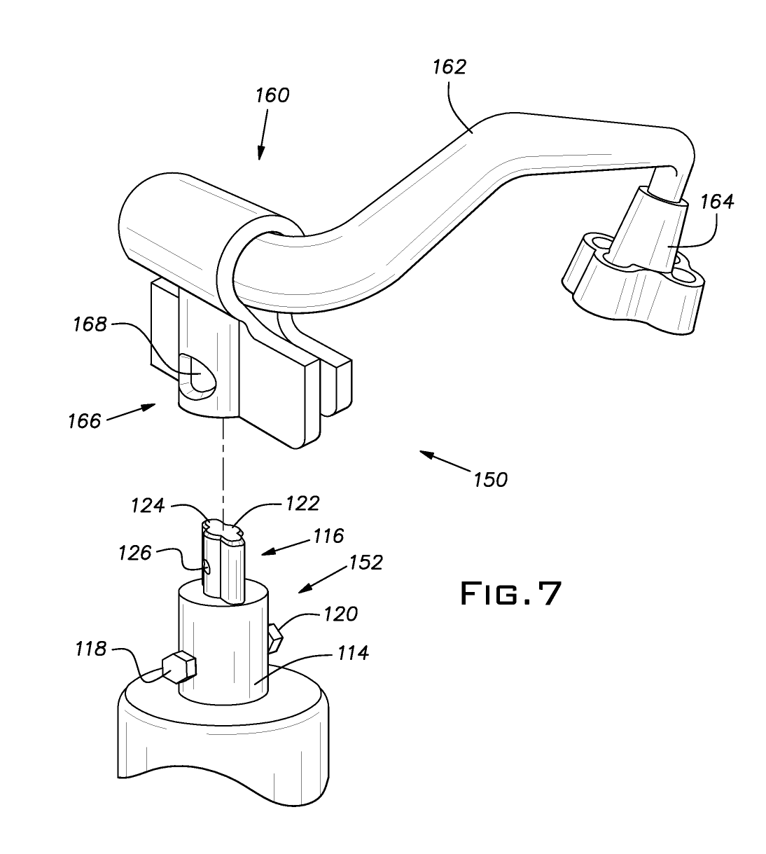

Referring now to FIG. 7, another embodiment of the invention is indicated by the reference numeral 150. The embodiment 150 shares certain features of the embodiments 10 and 110, and like reference numerals will be used to indicate the same or similar features of the various embodiments.

The embodiment 150 includes an adapter 152. The adapter 152 is substantially identical to the adapter 112. The embodiment 150 includes a crank 160. The crank 160 has an elongate shaft 162, a handle 164 at one end of the shaft 162, and a drive member 166 at the other end of the shaft 162. The drive member 166 is of a size and shape to fit over, and engage, the second end 116 of the adapter 152. The drive member 166 includes an opening 168 that is adapted to receive a bolt such as the bolt 118, which can be retained in place by a nut 120.

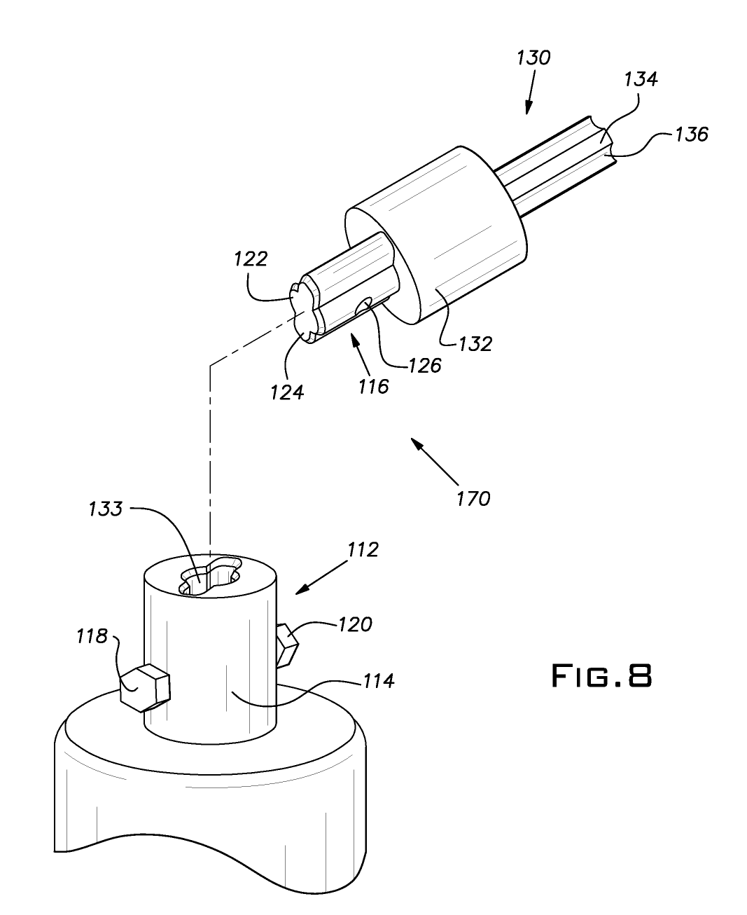

Referring now to FIG. 8, another embodiment of the invention is indicated by the reference numeral 170. The embodiment 170 is similar to the embodiment 110 except that the second end 116 extends from the first end 132 of the drive member 130, while the opening 133 is formed in the exposed end of the adapter 112. Essentially, the embodiments 110, 170 have a reversal of connected drive elements. In this embodiment 170, aligned, opposed openings (not shown) can be provided for the adapter 112 in order to permit a bolt and nut (not shown) to engage the opening 126, if desired, and thereby retain the drive member 130 in place. Similarly, a drive member similar to the drive member 130 could be attached to a crank similar to the crank 160 and held in place by the bolt and nut.

Most of the components of the embodiments 10, 70, 90, 110, 140, 150, 170 are made of commonly available materials such as stainless steel or chrome-plated steel. Typical dimensions for certain of the components are as follows. It is to be understood that these dimensions are approximations and variations can be made without affecting the efficacy of the invention.

exposed end 26: ½ inch diameter

opening 28: ⅜ inch diameter

adapter 30: 2¾ inches overall length, ½ inch I.D. of first end 32, ⅜ inch diameter of opening 33, 5/16 diameter of shaft 36, ¾ inch length of second end 34

socket 40: 3¾ inches overall length, ⅛ inch thick sidewall 46, ¾ inch length of second end 44 with 5/16 inch hex end

cranks 60, 84: 8 inches long

opening 74: ½ inch diameter

drive shaft 76: ½ inch diameter, 5 inches long

socket 82: 3 inches overall length

drive shaft 92: ½ inch diameter (one inch diameter for heavy duty applications)

opening 96: ⅜ inch diameter (½ inch diameter for heavy duty applications)

tension pin for embodiment 90: sized to fit opening 96.

### Operation

In embodiment 10, the first end 32 of the adapter 30 is fitted over the exposed second end 26 of the carrier shaft 24, the openings 28, 33 are aligned, and the tension pin 38 is press-fitted or otherwise non-removably held in place within the aligned openings 28, 33. By this construction, the adapter 30 is non-removably mounted to the exposed end 26. If a relatively loosely fit tension pin 38 is provided, the socket 40 is placed over the adapter 30 such that the tension pin 38 is retained in place by being covered by the lower end of the sidewall 46. Also, if the tension pin 38 is removable, the adapter 30 can be removed and taken from place to place or used on other trailer jacks having a similar construction. Such a feature could be useful, for example, in conjunction with semi-trailers that pass temporarily through many different places and that may be under the control of different people.

If the adapter 30 is non-removable, the security shape of the second end 34 will prevent or tend to prevent unauthorized operation of the jack. If the adapter 30 is removable, the exposed end 26 will be accessible when the jack is not being operated. It is expected that the exposed end 26 will not be easily grasped which will serve as a deterrent to unauthorized jack operation.

So long as the adapter 30 is held in place by the tension pin 38, the first end 42 of the socket 40 can engage the second end 34 of the adapter 30 and thereby establish a driving relationship with the carrier shaft 24. The chuck 54 can be affixed to the second end 44 of the socket 40. Thereafter, the motor 52 can be operated so as to rotate the carrier shaft 24 in a desired direction and extend or retract the base plate 18.

In embodiment 70, the socket 82 is fitted over the second end 80 of the drive shaft 76 so that the socket 82 and the drive shaft 76 engage each other in a driving relationship. The chuck 54 is affixed to the second end 44 of the socket 82. Thereafter, the motor 52 can be operated so as to rotate the carrier shaft 24 in a desired direction and thereby extend or retract the base plate 18. The embodiment 90 is assembled and operated in the same manner as the embodiment 10. In all embodiments, the cranks 60, 84 can be used to engage the drive ends 34, 44, or 80, as the case may be, in order to operate the jack 10 in the event that the drill 50 is not available or is inoperative.

Embodiments 110, 140, 150, 170 essentially operate in the same manner as embodiments 10, 70, 90. In each instance, an adapter is secured to the end portion of a carrier shaft or drive shaft, a drive member is provided that can engage the adapter in a driving relationship, and a power source such as an electric drill or a crank can be connected to the drive member so as to rotate the drive member, adapter and carrier shaft or drive shaft. In these embodiments a “security configuration” has been disclosed in the form of an elongate center portion 122 from which flanges 124 laterally project. It will be appreciated that many other forms of security configurations could be provided, if desired.

As will be apparent from the foregoing description, the invention can significantly reduce the time and effort required to operate a trailer jack. It is believed that the invention can enable a user to operate the jack in only about 10% of the time and with far less effort than required to operate the jack manually. The invention can be provided as part of new construction or as an aftermarket kit that can be used to retrofit existing jacks. The invention is particularly effective because battery-operated electric drills are available to many users and commonly are carried in a truck or other towing vehicle. When supplied in the preferred embodiment, the invention will make it difficult for unauthorized persons to operate the jack, thereby serving as an impediment to theft of the object that is being supported by the jack. The invention is inexpensive and practical, and avoids the drawbacks associated with prior devices of a similar nature.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents.

What is claimed is:

1. Apparatus for operating a trailer jack or similar device having a carrier shaft or drive shaft with a longitudinal axis about which the carrier shaft or drive shaft can rotate, the carrier shaft or drive shaft having an exposed end portion, comprising:
an adapter having first and second ends, the first end being connectable to the end portion of the carrier shaft or drive shaft in driving relationship;
a drive member having first and second ends, the first end of the drive member being connectable to the second end of the adapter in driving relationship and the second end of the drive member being connectable to a driving member such as a drill chuck; and
wherein the second end of the adapter has a configuration that is not amenable to being grasped or operated by commonly available tools.

2. The apparatus of claim 1, in which:
the second end of the adapter is a male member; and
the first end of the drive member includes an opening of a size and shape adapted to receive the second end of the adapter therein.

3. The apparatus of claim 1, in which:
the first end of the drive member is a male member; and
the second end of the adapter includes an opening of a size and shape adapted to receive the first end of the drive member adapter therein.

4. The apparatus of claim 1, further comprising a crank having first and second ends, a drive member being included as part of the first end and a handle being included as part of the second end, and wherein the drive member included as part of the first end of the crank can be connected to the second end of the adapter in driving relationship.

5. The apparatus of claim 1, in which the second end of the adapter is in the form of an elongate center portion from which a pair of laterally extending flanges project, the center portion and the flanges extending along an axis coincident with the longitudinal axis when the adapter is attached to the first end of the carrier shaft or drive shaft in driving relationship.

6. The apparatus of claim 5, further comprising:
a crank having first and second ends, a drive member being included as part of the first end and a handle being included as part of the second end;
the drive member included as part of the first end of the crank being connectable connected to the second end of the adapter in driving relationship and including aligned transverse openings;
a transverse opening in the center portion, the transverse opening in the center portion being aligned with the transverse openings in the drive member when the drive member is connected to the second end of the adapter;
a bolt that can be fitted through the aligned openings in the drive member and the adapter; and
a nut that can be connected to the bolt to retain the bolt in place and thereby secure the adapter to the exposed end portion.

7. The apparatus of claim 1, further comprising:
a transverse opening in the exposed end portion of the drive shaft;
transverse openings in the adapter, the transverse openings in the exposed end portion and the adapter being aligned with each other when the adapter is connected to the exposed end portion;
a bolt that can be fitted through the aligned openings in the exposed and portion and the adapter; and
a nut that can be connected to the bolt to retain the bolt in place and thereby secure the adapted to the exposed end portion.

8. The apparatus of claim 1, in which:
the adapter is connected to the end portion of the carrier shaft or drive shaft by means of a tension pin;
the first end of the drive member is extends about the second end of the adapter such that it covers the tension pin; and
the drive member includes an internal socket of a size and shape that engages the second end of the adapter in driving relationship.

9. The apparatus of claim 8, in which the tension pin is removable from the first adapter and the end portion of the carrier shaft or drive shaft when the drive member is removed from the adapter, whereby the adapter can be removed from the end portion of the carrier shaft or drive shaft if the drive member is disengaged from the adapter.

10. The apparatus of claim 8, in which the tension pin is not removable from the first adapter and the end portion of the carrier shaft or drive shaft when the drive member is removed from the adapter, whereby the adapter cannot be removed from the end portion of the carrier shaft or drive shaft if the drive member is disengaged from the adapter.

11. Apparatus for operating a trailer jack or similar device having a carrier shaft or drive shaft with a longitudinal axis about which the carrier shaft or drive shaft can rotate, the carrier shaft or drive shaft having an exposed end portion, comprising:
an adapter having first and second ends, the first end being connectable to the end portion of the carrier shaft or drive shaft in driving relationship;
a transverse opening in the exposed end portion of the carrier shaft or drive shaft;
transverse openings in the adapter, the transverse openings in the exposed end portion and the adapter being aligned with each other when the adapter is connected to the exposed end portion;
a bolt that can be fitted through the aligned openings in the exposed and portion and the adapter;
a nut that can be connected to the bolt to retain the bolt in place and thereby secure the adapter to the exposed end portion;
the second end of the adapter being in the form of a male member having a configuration that is not amenable to being grasped or operated by commonly available tools; and
a drive member having first and second ends, the first end of the drive member including an opening that is connectable to the male member of the adapter in driving relationship and the second end of the drive member being connectable to a driving member such as a drill chuck.

12. The apparatus of claim 11, further comprising:
a crank having first and second ends, a drive member being included as part of the first end and a handle being included as part of the second end, the drive member being connectable to the second end of the adapter in driving relationship and including aligned transverse openings;
a transverse opening in the male member, the transverse opening in the male member being aligned with the transverse openings in the drive member included as part of the crank when the drive member included as part of the crank is connected to the second end of the adapter;
a bolt that can be fitted through the aligned openings in the drive member included as part of the crank and the male member; and
a nut that can be connected to the bolt to retain the bolt in place and thereby secure the drive member included as part of the crank to the male member.

13. The apparatus of claim 11, in which the male member is in the form of an elongate center portion from which a pair of laterally extending flanges project, the center portion and the flanges extending along an axis coincident with the longitudinal axis when the adapter is attached to the first end of the carrier shaft or drive shaft in driving relationship.

14. A method for operating a trailer jack having a carrier shaft or drive shaft with a longitudinal axis about which the carrier shaft or drive shaft can rotate, an exposed end portion of the carrier shaft or drive shaft, and an opening in the exposed end portion extending generally transverse to the longitudinal axis, comprising the steps of:
providing an adapter having a longitudinal axis and first and second ends, the first end being configured to be disposed about the exposed end portion of the carrier shaft or drive shaft and the second end having a predetermined configuration that is not amenable to being grasped by commonly available tools, the longitudinal axes of the carrier shaft or drive shaft and the adapter being coincident with each other when the adapter is disposed in position about exposed end portion of the carrier shaft or drive shaft;
connecting the adapter to the exposed end portion in driving relationship;
providing a drive member having a longitudinal axis and first and second ends, the first end being configured to engage the second end of the adapter in driving relationship and the second end having a predetermined configuration that is amenable to being engaged by a driving member, the longitudinal axes of the adapter and the socket being coincident with each other when the socket is connected to the adapter;
connecting the first end of the drive member to the second end of the adapter in driving relationship;
providing an electric drill having a chuck;
connecting the chuck to the second end of the drive member in driving relationship; and
actuating the electric drill in order to rotate the chuck, drive member, adapter and carrier shaft or drive shaft in a desired direction.

15. The method of claim 14, wherein the trailer jack as provided by the manufacturer includes a crank having a drive end that is connected to the opening in driving relationship in order to permit a user to manually actuate the trailer jack, and further comprising the step of removing the crank from the exposed end portion prior to the step of connecting the adapter to the exposed end portion in driving relationship.

16. The method of claim 14, wherein if the electric drill is not available or is inoperative, further comprising the steps of:
providing a crank having a first end and a second end, a drive member being included as part of the first end and a handle being included as part of the second end; and
connecting the drive member of the crank to the second end of the adapter in driving relationship in order to permit a user to manually actuate the trailer jack.

17. The method of claim 16, further comprising the step of securing the drive member of the crank to the second end of the adapter such that the crank cannot be displaced or removed from the adapter during jack operations.
